(19) United States
(12) Patent Application Publication
(10) Pub. No.: US 2026/0371406 A1
(43) Pub. Date: Nov. 19, 2026

(54) COVERAGE ENHANCEMENT IN RANDOM ACCESS PROCEDURE

(71) Applicant: Apple Inc., Cupertino, CA (US)

(72) Inventors: Chunhai Yao, Beijing (CN); Ankit Bhamri, Bad Nauheim (DE); Chunxuan Ye, San Diego, CA (US); Dan Wu, Beijing (CN); Dawei Zhang, Saratoga, CA (US); Haitong Sun, Saratoga, CA (US); Hong He, San Jose, CA (US); Oghenekome Oteri, San Diego, CA (US); Seyed Ali Akbar Fakoorian, San Diego, CA (US); Wei Zeng, Saratoga, CA (US)

(21) Appl. No.: 19/155,333

(22) PCT Filed: Feb. 17, 2023
(86) PCT No.: PCT/CN2023/076812

§ 371 Date: Aug. 11, 2025

(51) Int. Cl. H04W 74/0838; H04W 76/10

(52) U.S. Cl. CPC H04W 74/0838; H04W 76/10

(57) ABSTRACT

Disclosed are methods, systems, and computer-readable medium to perform operations including: receiving a signaling message from a base station, the signaling message including information about one or more random access (RA) repetition levels, the one or more RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and establishing a connection with the base station based at least on the information about random access (RA) repetition levels.

### BACKGROUND

Wireless communication networks provide integrated communication platforms and telecommunication services to wireless user devices. Example telecommunication services include telephony, data (for example, voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

New radio (NR) network coverage is affected by the ability of user equipment (UE) to receive an uplink (UL) allocation from a base station, for example, a gNodeB (gNB) or an eNodeB (eNB). Network coverage can be improved through uplink coverage enhancements in the random access channel (RACH) procedure. This can be achieved by including information about random access (RA) repetition levels associated with transmissions between the UE and the base station. The RA repetition levels can include a physical random access channel (PRACH) repetition level, a message 3 (Msg3) physical uplink shared channel (PUSCH) repetition set, or a physical uplink control channel (PUCCH) repetition for message 4 (Msg4) hybrid automatic repeat request acknowledgement (HARQ-ACK), or any suitable combination of these.

In accordance with one aspect of the present disclosure, a method is performed by a UE. The method involves receiving a signaling message from a base station, the signaling message including information about one or more RA repetition levels, the one or more RA repetition levels including at least one of a PRACH repetition number, a Msg3 PUSCH repetition set, or a PUCCH repetition number for Msg4 HARQ-ACK; and establishing a connection with the base station based at least on the information about RA repetition levels.

In accordance with one aspect of the present disclosure, a method is performed by a base station. The method involves transmitting, to a UE, a signaling message including information about one or more RA repetition levels, the RA repetition levels including at least one of a PRACH repetition number, a Msg3 PUSCH repetition set, or a PUCCH repetition number for Msg4 HARQ-ACK; and establishing a connection with the UE based at least on the information about RA repetition levels.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example message exchange for coverage enhancement between a UE and a base station, according to some implementations.

FIG. 3 illustrates a flowchart of an example method, according to some implementations.

FIG. 4 illustrates a flowchart of an example method, according to some implementations.

FIG. 5 illustrates a UE, according to some implementations.

FIG. 6 illustrates an access node, according to some implementations.

### DETAILED DESCRIPTION

An objective of 3GPP Release 18 (Rel-18) is PRACH coverage enhancement for communications between a UE and a base station. Enhancements can be made to Radio Layer 1 (RAN1) and Radio Layer 2 (RAN2). Coverage can be enhanced by using multiple PRACH transmissions with the same beams or with different beams for the 4-step RACH procedure. The enhancements of PRACH are targeted for frequency band 2 (FR2) and can also apply to frequency band 1 (FR1). In some examples, the enhancements of PRACH target short PRACH formats. Support for multiple PRACH repetition levels can enhance coverage. The base station (for example, a gNB or an eNB) can configure either one or multiple values for the number of multiple PRACH transmissions with same transmission beam. For example, when multiple values are used, multiple PRACH transmissions can be sent at the same time using multiple radios for the repetitions.

NR Non-Terrestrial Networks (NTN) enhancements can include PUCCH) repetitions for Msg4 HARQ-ACK. For example, enhancements can be made to RAN1 and/or radio level 4 (RAN4). The objectives for NTN include study of demodulation reference signal (DMRS) bundling for PUSCH, taking into account NTN-specifics (for example, time-frequency pre-compensation) and, in some cases, specify enhancements to RA procedures described in 3GPP Release 17 (Rel-17) (for example, RAN 1). RAN1 #110b is agreements on PUCCH enhancement for Rel-18 enhanced NTN include options of procedure to perform PUCCH repetitions for Msg4 HARQ-ACK.

In some examples, the UE can perform repetitions if configured in a cell-specific manner. This can be based on details of the cell-specific configuration and the behavior of UEs incapable of repetition. In some examples, the UE can request repetition and can be dynamically indicated to perform repetition. This can be based on the details of repetition request and the details of the configuration and dynamic repetition indication. In some examples, the UE can indicate repetition capability and can be dynamically indicated to perform repetition. In some examples, the UE can indicate a repetition capability before Msg4.

The RAN1 #111 agreements on PUCCH enhancement for Rel-18 enhanced NTN include that, for PUCCH repetition for Msg4 HARQ-ACK, one or more repetition factors may be configured via system information block (SIB). If only one repetition factor is configured via SIB and if the value is one of {[1], 2, 4, 8}, UEs capable of PUCCH repetition for Msg4 HARQ-ACK can perform repetition with the repetition factor (for example, repetition number). This can be based on whether a UE requests repetition or indicates repetition capability. If multiple factors from {1, 2, 4, 8} are configured via the SIB, PUCCH repetition for Msg4 HARQ-ACK may be dynamically determined and indicated by the base station. This can be based on whether the UE requests repetition or indicates repetition capability, and whether the repetition factor is indicated by the UE. A UE behavior (for example, a default behavior) can be specified for when a repetition factor is not configured via the SIB.

Functionalities may be selected based on UE capabilities to support the uplink (UL) coverage enhancements in the random access (RA) procedure. When multiple RA repetition levels are used, the PRACH repetition number, message 3 (Msg3) PUSCH repetition number set, and PUCCH repetition number for Msg4 HARQ-ACK can be associated with each other.

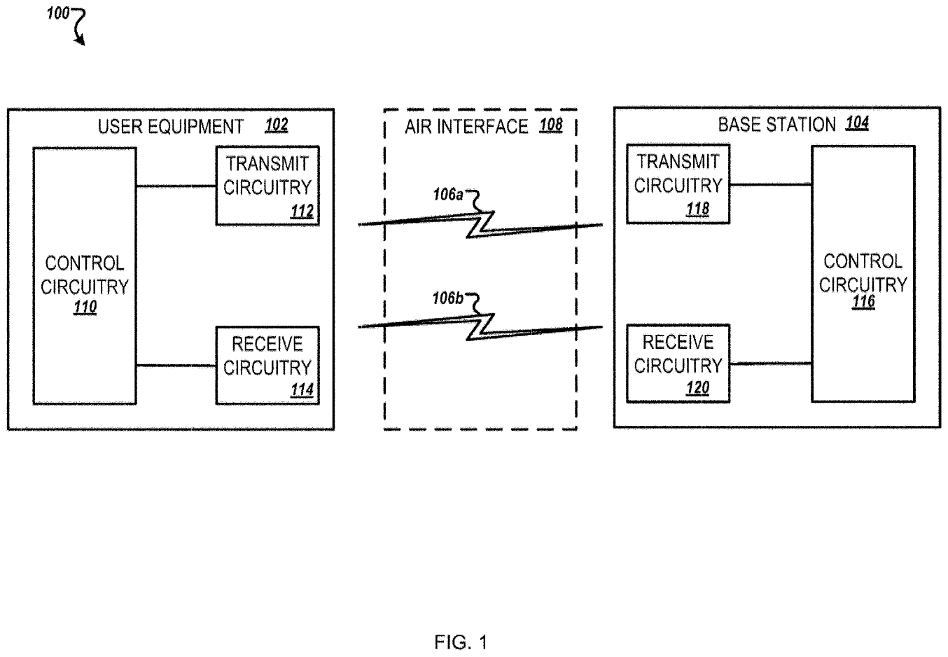

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (for example, Sixth Generation (6G)) systems, Institute of Electrical and Electronics Engineers (IEEE) 802.11 technology (for example, IEEE 802.11a; IEEE 802.11b; IEEE 802.11g; IEEE 802.11-2007; IEEE 802.11n; IEEE 802.11-2012; IEEE 802.11 ac; or other present or future developed IEEE 802.11 technologies), IEEE 802.16 protocols (for example, WMAN, WiMAX, etc.), or the like. While aspects may be described herein using terminology commonly associated with 5G NR, aspects of the present disclosure can be applied to other systems, such as 3G, 4G, and/or systems subsequent to 5G (for example, 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can determine random access (RA) repetition levels. In some implementations, the RA repetition levels can be determined based on information received in a SIB and/or a random access response (RAR) received from the base station 104.

The transmit circuitry 112 can perform various operations described in this specification. For example, the transmit circuitry 112 can transmit a RA preamble, a Msg3 PUSCH, and/or a PUCCH for Msg4 HARQ-ACK.

Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive a SIB1, a RAR, and/or a Msg4. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (for example, messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104.

The transmit circuitry 118 may transmit downlink physical channels includes of a plurality of downlink subframes. The transmit circuitry 118 can perform various operations described in this specification. For instance, the transmit circuitry 118 can transmit a SIB1, a RAR, and/or a Msg4.

The receive circuitry 120 may receive a plurality of uplink physical channels from various UEs, including the UE 102. The receive circuitry 120 can perform various operations described in this specification. For example, the receive circuitry 120 can transmit a RA preamble, a Msg3 PUSCH, and/or a PUCCH for Msg4 HARQ-ACK.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

RA repetition levels can include the PRACH repetition level, Msg3 PUSCH repetition set, and PUCCH repetition number for Msg4 HARQ-ACK. These three features can be associated with one another, as described below. The PRACH Repetition level can include one or more PRACH repetition numbers. The Msg3 PUSCH repetition set can include one or more candidate repetition values (for example, set {1, 2, 4, 8} in some cases), and a Msg3 PUSCH repetition number can be dynamically determined from the Msg3 PUSCH repetition set. In some implementations, the PRACH repetition level can be determined, and then an associated Msg3 PUSCH repetition set and PUCCH repetition for Msg4 HARQ-ACK can be determined based on the PRACH repetition level. In some examples, the multiple PRACH repetition levels can be defined by the base station 104.

Multiple RA repetition levels can be indicated by system information block 1 (SIB1). The SIB1 can include associations between the PRACH repetition level, Msg3 PUSCH repetition set, and PUCCH repetition number for Msg4 HARQ-ACK. In some cases, the PRACH repetition number, the Msg3 PUSCH repetition number set, and the PUCCH repetition for Msg4 HARQ-ACK can be configured independently. In some cases, the PRACH repetition number, and the Msg3 PUSCH repetition number set can be configured jointly. For example, each RA repetition level can include one PRACH repetition level and one Msg3 PUSCH repetition set. In some cases, the PUCCH repetition for Msg4 HARQ-ACK can be jointly configured with the PRACH repetition and the Msg3 PUSCH repetition. For example, each RA repetition level can include one PRACH repetition level, one Msg3 PUSCH repetition set, and one PUCCH repetition number. When repetition levels are configured jointly, the multiple RA repetition levels indicated by SIB1 can include all the jointly configured repetition levels.

Multiple SSB-RSRP thresholds can be configured when multiple RA repetition levels are configured. Each RSRP threshold can be associated with one RA repetition level. For example, a unified RSRP threshold can be configured for PRACH repetition, Msg3 PUSCH repetition, and PUCCH repetition. When a RSRP value measured by the UE satisfies (for example, is better than) a RSRP threshold (for example, the closest RSRP threshold), the corresponding RA repetition level can be selected. Separate SSB-RSRP can be configured for components not included in the RA repetition level (for example, a RSRP threshold for PUCCH repetition when the PRACH repetition number and the Msg3 PUSCH repetition number set are jointly configured).

In some cases, a fallback mode can be used, for example, when only one RA repetition level is configured. In some implementations, the RA repetition level can include only one PRACH repetition number. One RSRP threshold can be configured for Msg3 PUSCH repetition and reused. For example, the rsrp-ThresholdMsg3 can be used for determining the PRACH repetition and the PUCCH repetition. When the UE measured SSB RSRP is lower than the threshold, the UE can select the PRACH resources for repetition, and the UE can determine the PUCCH repetition number indicated by SIB1.

In some implementations, the PRACH repetition number, Msg3 PUSCH repetition number, and PUCCH repetition number can be associated with one another in fallback mode as follows. For example, in some cases, if the PRACH repetition number=1, then Msg3 PUSCH repetition number set is {1, 2, 3, 4}, and PUCCH repetition for Msg4 HARQ-ACK=1. In such an example, the value of 1 can correspond to no repetition. As another example, if the PRACH repetition number=4, Msg3 PUSCH repetition number set is {4, 8, 12, 16}, and PUCCH repetition for Msg4 HARQ-ACK=4. In some implementations, the PRACH link budget can be better than Msg3 PUSCH, and the UE does not expect the Msg3 PUSCH repetition to be smaller than the PRACH repetition number. In some cases, to achieve the association between PRACH repetition number and Msg3 PUSCH repetition number, the Msg3 PUSCH repetition range can be specified to be {n1, n2, n3, n4, n7, n8, n12, n16, n18, n20, n22, n24, n26, n28, n30, n32}. For example, the BWP-UplinkCommon information element as described in TS 38.331 can be modified, as follows:

```
    BWP-UplinkCommon ::= SEQUENCE {
  genericParameters BWP,
```

| rach-ConfigCommon | SetupRelease {RACH-ConfigCommon} | OPTIONAL, |
|---|---|---|
| -- Need M | | |
| pusch-ConfigCommon | SetupRelease {PUSCH-ConfigCommon} | OPTIONAL, |
| -- Need M | | |
| pucch-ConfigCommon | SetupRelease {PUCCH-ConfigCommon} | OPTIONAL, |
| -- Need M | | |
| . . . , | | |
| [[ | | |
| rach-ConfigCommonIAB-r16 | SetupRelease {RACH-ConfigCommon} | OPTIONAL, |
| -- Need M | | |
| useInterlacePUCCH-PUSCH-r16 | ENUMERATED {enabled} OPTIONAL, -- | |
| Need R | | |
| msgA-ConfigCommon-r16 | SetupRelease { MsgA-ConfigCommon-r16 } | |
| OPTIONAL -- Cond SpCellOnly2 | | |
| ]], | | |
| [[ | | |
| enableRA-PrioritizationForSlicing-r17 | BOOLEAN OPTIONAL, -- Ccond RAPrioSliceAI | |
| additionalRACH-ConfigList-r17 | SetupRelease {AdditionalRACH-ConfigList-r17} | |
| OPTIONAL, -- Cond SpCellOnly2 | | |
| rsrp-ThresholdMsg3-r17 RSRP-Range | OPTIONAL, -- Need R | |
| numberOfMsg3-RepetitionsList-r17 | | |

SEQUENCE (SIZE (4)) OF NumberOfMsg3-Repetitions-r17 OPTIONAL,

-- Cond Msg3Rep

```
  mcs-Msg3-Repetitions-r17 SEQUENCE (SIZE (8)) OF INTEGER (0 . . . 31)
    OPTIONAL -- Cond Msg3Rep
  ]]
}
AdditionalRACH-ConfigList-r17 ::= SEQUENCE (SIZE(1 . . . maxAdditionalRACH-r17)) OF
AdditionalRACH-Config-r17
AdditionalRACH-Config-r17 ::= SEQUENCE {
    rach-ConfigCommon-r17 RACH-ConfigCommon
  OPTIONAL, -- Need R
    msgA-ConfigCommon-r17 MsgA-ConfigCommon-r16
  OPTIONAL, -- Need R
    . . .
}
NumberOfMsg3-Repetitions-r17 ::= ENUMERATED {n1, n2, n3, n4, n7, n8, n12, n16, n18,
n20, n22, n24, n26, n28, n30, n32}
One Repetition level for Msg3: {n1, n2, n3, n4}
Multiple repetition levels,
      Candidate set for repetition:
        Level 1 {n1, n2, n3, n4} -> PRACH level 1: 2 repetitions
        Level 2 {n3, n4, n5, n8} -> PRACH level 2: 4 repetitions
```

The set of Msg3 repetitions can be expanded to include additional numbers. In some implementations, one repetition level can be used for Msg3. In some implementations, multiple repetition levels can be used for Msg3. In such implementations, a candidate set for Msg3 and a repetition number for PRACH can be defined for each level.

As indicated above, the PUCCH repetition for Msg4 HARQ-ACK can be determined based on the RA repetition levels. In some implementations, the SIB can indicate the PUCCH repetition for Msg4 HARQ-ACK. For example, the RA repetition level can include the PUCCH repetition number when only a single PUCCH repetition number is indicated by SIB1. In some implementations, the PUCCH repetition for Msg4 HARQ-ACK can be indicated dynamically. For example, the RA repetition level may not include the PUCCH repetition number when multiple PUCCH repetition numbers are indicated by SIB1. In some implementations, when a single RA repetition level is configured, a new SSB-RSRP threshold can be defined for the PUCCH repetition request. In other implementations, when a single RA repetition level is configured, the RSRP threshold configured for Msg3 PUSCH repetition can be reused for the PUCCH repetition request. The RSRP thresholds can be based on the network configuration. In some implementations, when multiple RA repetition levels are used, a common RSRP threshold for the RA repetition level can be used to determine the PUCCH repetition number.

In some implementations, RA repetition levels can be determined for contention free random access (CFRA). The preambles used by CFRA can include preambles in a shared RACH occasion (RO) with the legacy UE. The preambles used by CFRA can include preambles in a dedicated RO. The CFRA preamble can be in the same RO as contention based random access (CBRA). Radio resource control (RRC) can be used to configure the dedicated CFRA preamble with the repetition number, Msg3 repetition number set, or PUCCH repetition number for Msg4 HARQ-ACK. For example, RRC can be used to configure the RA repetition when the UE is already in RRC connection mode.

In some implementations, the RA repetition level can be indicated via downlink control information (DCI) format 1_0 in the case of a physical downlink control channel (PDCCH) order. In some examples, a new field of PRACH repetition level can be introduced (for example, the reserved bits in DCI could be used). In some examples, another field can be introduced to indicate the Msg3 PUSCH repetition set associated with the PRACH repetition level. In some examples, the association between PRACH repetition level with the Msg3 PUSCH repetition can be reused. In some implementations, the Msg3 PUSCH repetition can be indicated by random access response (RAR) as Msg3 PUSCH repetition for CBRA. The Msg3 PUSCH repetition number set can be indicated by the SIB.

In some implementations, RA repetition levels can be determined based on UE capabilities for the RA procedure. The UL coverage enhancements for random access procedure can include PRACH repetition, Msg3 PUSCH repetition, and PUCCH repetition for Msg4 HARQ-ACK. For a Rel-17 UE, Msg3 PUSCH repetition can be supported by a UE with suitable capabilities. A Rel-18 UE can be configured to support PRACH repetition and Msg3 PUSCH repetition. In some implementations, Rel-18 NTN capable UE can be configured to support PRACH repetition, Msg3 PUSCH repetition, and PUCCH repetition for Msg4 HARQ-ACK.

The UE capability for coverage enhancements in the RACH procedure can be reported per frequency band. When the UE supports PRACH repetition, the prerequisite of this feature can include supporting Msg3 PUSCH repetition, i.e., FG 30-6 Repetition of PUSCH transmission scheduled by RAR UL grant and DCI format 0_0 with CRC scrambled by TC-RNTI. When the UE supports PUCCH repetition for Msg4 HARQ-ACK, the prerequisite can include supporting Msg3 PUSCH repetition. When the UE supports PUCCH repetition for Msg4 HARQ-ACK, the prerequisite can include supporting Msg3 PUSCH repetition and PRACH repetition. When the UE reports capability of coverage enhancements in the RACH procedure, the UE can support PRACH repetition, Msg3 PUSCH repetition, and PUCCH repetition for Msg4 HARQ-ACK. For example, UE can include a NTN UE. The reported UE capability can include supporting coverage enhancements in the RACH procedure for CFRA.

As described above, the RA repetition level can include the PRACH repetition number, Msg3 PUSCH repetition set, and PUCCH repetition number. Multiple or single RA repetition levels can be configured by the network. As an example, SIB1 can indicate a PRACH repetition level 1 including a PRACH repetition number of 2, Msg3 PUSCH repetition set of {2,3,4,7}, and a PUCCH repetition number of 2. The exact Msg3 repetition number from the Msg3 PUSCH repetition set can be dynamically indicated by RAR or fallback DCI. The PUCCH repetition can be used by a NTN UE and terrestrial UEs can ignore this repetition. As another example, the SIB1 can indicate a PRACH repetition level 2 including a PRACH repetition number of 4, Msg3 PUSCH repetition set of {4,7, 8, 12}, and a PUCCH repetition number of 4. In some cases, when a single RA repetition level is configured, a Msg3 repetition method can be re-used (for example, by rsrp-ThresholdMsg3) to determine the PRACH repetition and PUCCH repetition. When the PRACH repetition=1, then the repetition can fall back to the Rel-17 Msg3 repetition.

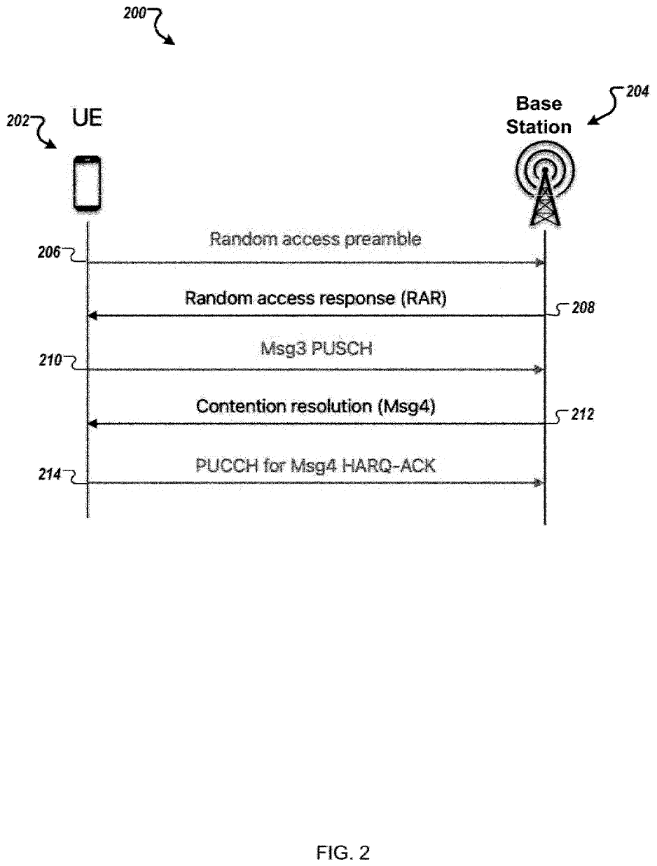

FIG. 2 illustrates an example message exchange 200 for coverage enhancement between a UE 202 and a base station 204, according to some implementations. In some implementations, the UE 202 is the same or similar to the UE 102 and the base station 204 is the same or similar to the base station 104.

At 206, the UE 202 can transmit a random access preamble (for example, message 1) to the base station 204. In some implementations, the UE can receive a SIB1 from the base station before transmitting the random access preamble. The random access preamble can include a request to connect to a broader network through the base station 204. The random access preamble can be sent on the PRACH at a random time. In some examples, the random access preamble can be selected randomly and is the same as a preamble from another UE. In such an example, there is a conflict between the UE 202 and the other UE, which can be resolved through Msg3 and Msg4.

At 208, the base station 204 can transmit a random access response (RAR) (for example, message 2) to the UE 202. The RAR can reference the preamble it corresponds to, and can include a temporary identifier for UE 202 and a scheduling grant for sending the Msg3.

At 210, the UE 202 can transmit a Msg3 PUSCH to the base station 204. The Msg3 PUSCH can be transmitted based on information received in the RAR at 208. In some examples, the Msg3 PUSCH can conflict with a Msg3 from another UE (for example, the UEs randomly selected the same preamble, received the same temporary identifier, and transmitted conflicting Msg3).

At 212, the base station 204 can transmit a contention resolution (Msg4) to the UE 202. In some examples, the Msg4 can resolve conflicts between two or more UEs.

At 214, the UE 202 can transmit a PUCCH for Msg4 HARQ-ACK to the base station 204. The PUCCH for Msg4 HARQ-ACK can be transmitted after the conflict has been resolved for UE 202.

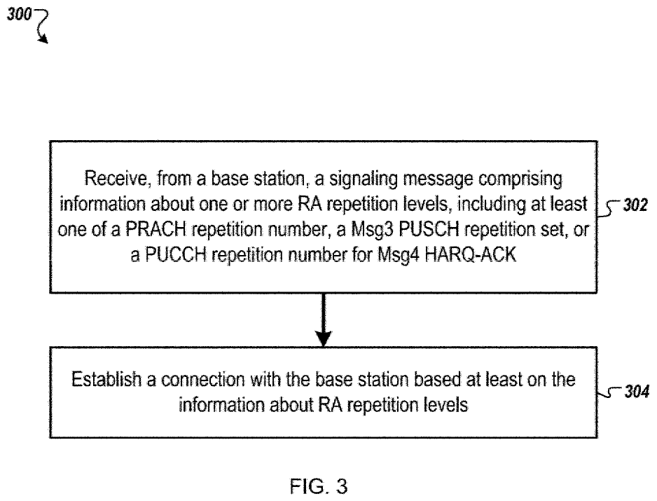

FIG. 3 illustrates a flowchart of an example method 300, according to some implementations. For clarity of presentation, the description that follows generally describes method 300 in the context of the other figures in this description. For example, method 300 can be performed by the UE 102 of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At 302, method 300 involves receiving a signaling message from a base station, the signaling message including information about one or more RA repetition levels, the one or more RA repetition levels including at least one of a PRACH repetition number, a Msg3 PUSCH repetition set, or a PUCCH repetition number for Msg4 HARQ-ACK.

At 304, method 300 involves establishing a connection with the base station based at least on the information about RA repetition levels.

The example method 300 shown in FIG. 3 can be modified or reconfigured to include additional, fewer, or different steps (not shown in FIG. 3), which can be performed in the order shown or in a different order.

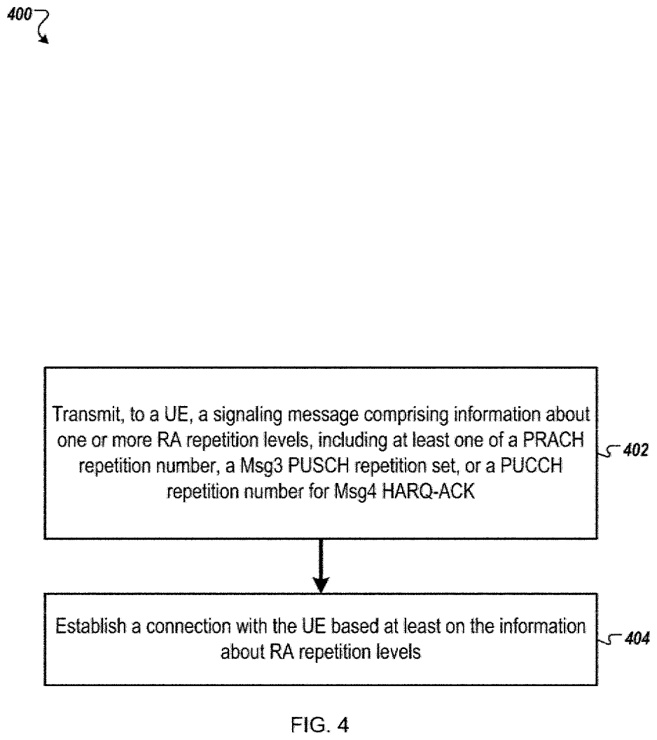

FIG. 4 illustrates a flowchart of an example method 400, according to some implementations. For clarity of presentation, the description that follows generally describes method 400 in the context of the other figures in this description. For example, method 400 can be performed by the base station 104 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At 404, method 400 involves transmitting, to a UE, a signaling message comprising information about one or more RA repetition levels, including at least one of a PRACH repetition number, a Msg3 PUSCH repetition set, or a PUCCH repetition number for Msg4 HARQ-ACK.

At 404, method 400 involves establishing a connection with the UE based at least on the information about RA repetition levels.

The example method 400 shown in FIG. 4 can be modified or reconfigured to include additional, fewer, or different steps (not shown in FIG. 4), which can be performed in the order shown or in a different order.

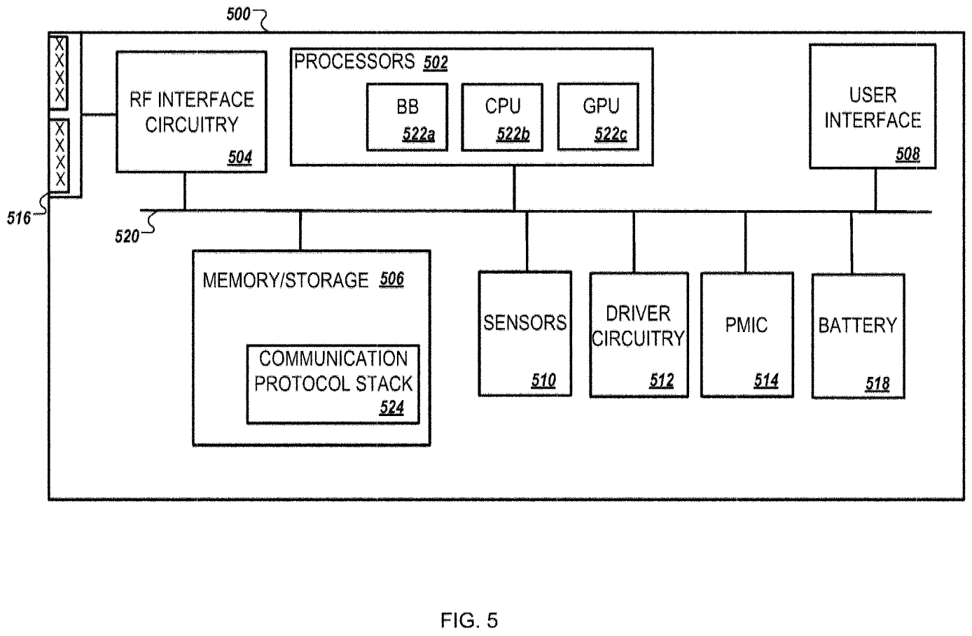

FIG. 5 illustrates a UE 500, according to some implementations. The UE 500 may be similar to and substantially interchangeable with UE 102 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 510 and control and allow access to sensor circuitry 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

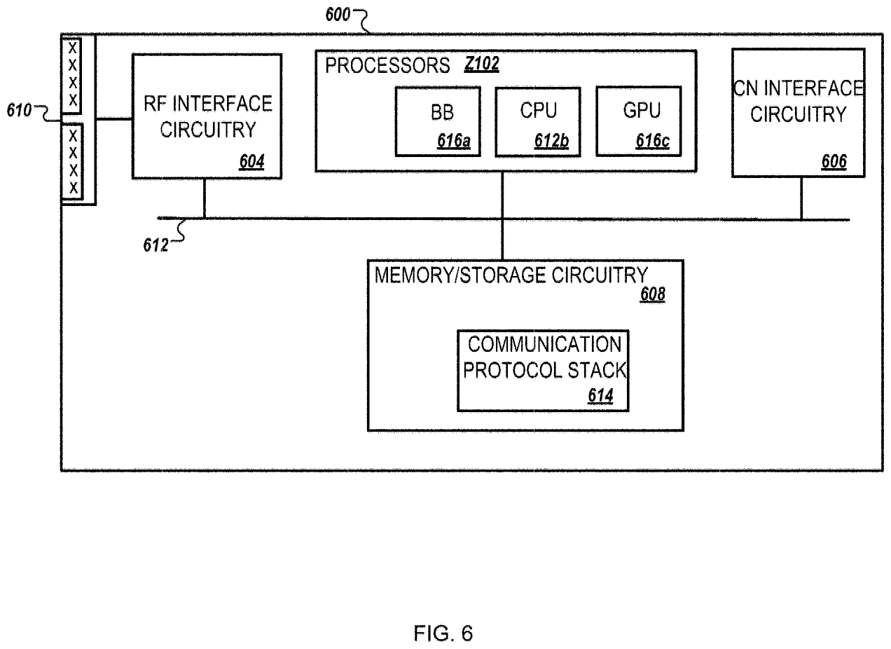

FIG. 6 illustrates an access node 600 (for example, a base station, gNB or eNB), according to some implementations. The access node 600 may be similar to and substantially interchangeable with base station 104 of FIG. 1. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (for example, terrestrial access points) or satellite stations providing coverage within a geographic area (for example, a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (for example, an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method performed by a user equipment (UE), the method comprising: receiving a signaling message from a base station, the signaling message including information about one or more random access (RA) repetition levels, the one or more RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and establishing a connection with the base station based at least on the information about random access (RA) repetition levels.

Example 2 includes the method of example 1, wherein the RA repetition levels include distinct values for the PRACH repetition number, the Msg3 PUSCH repetition set, and PUCCH repetition number for Msg4 HARQ-ACK.

Example 3 includes the method of example 1, wherein the RA repetition levels include a joint configuration for the PRACH repetition number and the Msg3 PUSCH repetition set.

Example 4 includes the method of example 1, wherein the RA repetition levels include a joint configuration for the PRACH repetition number, the Msg3 PUSCH repetition set, and the PUCCH repetition number for Msg4 HARQ-ACK.

Example 5 includes the method of example 1, wherein the RA repetition levels are indicated by a system information block type 1 (SIB1).

Example 6 includes the method of example 1, further comprising: receiving information about one or more synchronization signal block (SSB) reference signal received power (RSRP) thresholds, each RSRP threshold corresponding to a RA repetition level of the one or more RA repetition levels; measuring an RSRP value of a communications link between the UE and the base station; identifying a closest SSB-RSRP threshold of the one or more SSB-RSRP thresholds that is less than the measured RSRP value; and selecting an RA repetition level corresponding to the identified SSB RSRP threshold.

Example 7 includes the method of example 1, further comprising: determining that a single RA repetition level is indicated by system information block type 1 (SIB1) as a fallback mode, wherein the single RA repetition level corresponds to a PRACH repetition number; and determining the Msg3 PUSCH repetition set based on the single RA repetition level, wherein the Msg3 PUSCH repetition set includes one or more enumerated values, the one or more enumerated values being each greater than the PRACH repetition number.

Example 8 includes the method of example 7, further comprising: setting the PUCCH repetition for Msg4 HARQ-ACK to be equal to one of the PRACH repetition number or the single RA repetition level indicated by the SIB1.

Example 9 includes the method of example 1, further comprising: determining that a single RA repetition level is indicated by a SIB1; and in response to determining that a single RA repetition level is indicated by SIB1, determining an RSRP threshold for PUCCH repetition for Msg4 HARQ-ACK based on an RSRP threshold for Msg3 PUSCH repetition if PUCCH for Msg4 HARQ-ACK is not included in RA repetition level.

Example 10 includes the method of example 1, further comprising: determining that a plurality of RA repetition levels is indicated by a SIB1; and in response to determining that a plurality of RA repetition levels is indicated by SIB1, determining an RSRP threshold for PUCCH repetition for Msg4 HARQ-ACK based on a common RSRP threshold for the plurality of RA repetition levels.

Example 11 includes the method of example 1, wherein the signaling message comprises a contention free random access (CFRA) preamble including the RA repetition levels.

Example 12 includes the method of example 11, wherein the CFRA preamble is included in a shared RACH occasion (RO) with a legacy UE.

Example 13 includes the method of example 11, wherein the CFRA preamble is included in a dedicated RO that is configured for contention based random access (CBRA).

Example 14 includes the method of example 11, wherein a RA repetition level for CFRA is configured using radio resource control (RRC) to include at least one of the PRACH repetition number, the Msg3 PUSCH repetition set, or the PUCCH repetition number for Msg4 HARQ-ACK.

Example 15 includes the method of example 11, wherein at least one of the RA repetition levels is indicated using downlink control information (DCI) Format 1_0 for a physical downlink control channel (PDCCH) order.

Example 16 includes the method of example 1, further comprising: determining the UE supports PRACH repetition based at least on supporting Msg3 PUSCH repetition, wherein the Msg3 PUSCH repetition includes repetition of PUSCH transmissions scheduled by random access response (RAR) uplink (UL) grant and downlink control indicator (DCI) format 0_0 with cyclic redundancy check (CRC) scrambled by temporary cell radio network temporary identifier (TC-RNTI).

Example 17 includes the method of example 1, further comprising: determining the UE supports PUCCH repetition for Msg4 HARQ-ACK based at least on supporting Msg3 PUSCH repetition.

Example 18 includes the method of example 1, further comprising: determining the UE supports PUCCH repetition for Msg4 HARQ HARQ-ACK based at least on supporting Msg3 PUSCH repetition and PRACH repetition.

Example 19 includes the method of example 1, further comprising: determining the UE supports PRACH repetition, Msg3 PUSCH repetition, and PUCCH repetition for Msg4 HARQ HARQ-ACK based on the UE supporting coverage enhancements in a RACH procedure.

Example 20 includes the method of example 1, further comprising: reporting UE capability for coverage enhancements in RACH procedure per frequency band.

Example 21 includes a method performed by a base station, the method comprising: transmitting, to a user equipment (UE), a signaling message including information about one or more random access (RA) repetition levels, the RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and establishing a connection with the UE based at least on the information about random access (RA) repetition levels.

Example 22 may include one or more non-transitory computer-readable media including instructions to cause an electronic device, upon execution of the instructions by one or more processors of the electronic device, to perform one or more elements of a method described in or related to any of examples 1-21, or any other method or process described herein.

Example 23 may include an apparatus including logic, modules, or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus including: one or more processors and one or more computer-readable media including instructions that, when executed by the one or more processors, cause the one or more processors to perform the method, techniques, or process as described in or related to any of examples 1-21, or portions thereof.

Example 26 may include a signal as described in or related to any of examples 1-21, or portions or parts thereof.

Example 27 may include a datagram, information element, packet, frame, segment, PDU, or message as described in or related to any of examples 1-21, or portions or parts thereof, or otherwise described in the present disclosure.

Example 28 may include a signal encoded with data as described in or related to any of examples 1-21, or portions or parts thereof, or otherwise described in the present disclosure.

Example 29 may include a signal encoded with a datagram, IE, packet, frame, segment, PDU, or message as described in or related to any of examples 1-21, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 31 may include a computer program including instructions, wherein execution of the program by a processing element is to cause the processing element to carry out the method, techniques, or process as described in or related to any of examples 1-21, or portions thereof. The operations or actions performed by the instructions executed by the processing element can include the methods of any one of examples 1-21.

Example 32 may include a signal in a wireless network as shown and described herein.

Example 33 may include a method of communicating in a wireless network as shown and described herein.

Example 34 may include a system for providing wireless communication as shown and described herein. The operations or actions performed by the system can include the methods of any one of examples 1-21.

Example 35 may include a device for providing wireless communication as shown and described herein. The operations or actions performed by the device can include the methods of any one of examples 1-21.

The previously-described examples 1-21 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, for example, a UE or a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-21.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method performed by a user equipment (UE), the method comprising:
receiving a signaling message from a base station, the signaling message including information about one or more random access (RA) repetition levels, the one or more RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and
establishing a connection with the base station based at least on the information about the one or more RA repetition levels.

2. The method of claim 1, wherein the RA repetition levels include one of (i) distinct values for the PRACH repetition number, the Msg3 PUSCH repetition set, and PUCCH repetition number for Msg4 HARQ-ACK, (ii) a joint configuration for the PRACH repetition number and the Msg3 PUSCH repetition set, or (iii) the joint configuration for the PRACH repetition number, the Msg3 PUSCH repetition set, and the PUCCH repetition number for Msg4 HARQ-ACK.

3-4. (canceled)

5. The method of claim 1, wherein the RA repetition levels are indicated by a system information block type 1 (SIB1).

6. The method of claim 1, further comprising:
receiving information about one or more synchronization signal block (SSB) reference signal received power (RSRP) thresholds, each RSRP threshold corresponding to a RA repetition level of the one or more RA repetition levels;
measuring an RSRP value of a communications link between the UE and the base station;
identifying a closest SSB-RSRP threshold of the one or more SSB-RSRP thresholds that is less than the measured RSRP value; and
selecting an RA repetition level corresponding to the identified SSB-RSRP threshold.

7. The method of claim 1, further comprising:
determining that a single RA repetition level is indicated by system information block type 1 (SIB1) as a fallback mode, wherein the single RA repetition level corresponds to a PRACH repetition number; and
determining the Msg3 PUSCH repetition set based on the single RA repetition level, wherein the Msg3 PUSCH repetition set includes one or more enumerated values, the one or more enumerated values being each greater than the PRACH repetition number.

8. The method of claim 7, further comprising:
setting the PUCCH repetition for Msg4 HARQ-ACK to be equal to one of the PRACH repetition number or the single RA repetition level indicated by the SIB1.

9. The method of claim 1, further comprising:
determining that a single RA repetition level is indicated by a SIB1; and
in response to determining that the single RA repetition level is indicated by SIB1, determining an RSRP threshold for PUCCH repetition for Msg4 HARQ-ACK based on an RSRP threshold for Msg3 PUSCH repetition if PUCCH for Msg4 HARQ-ACK is not included in RA repetition level.

10. The method of claim 1, further comprising:
determining that a plurality of RA repetition levels is indicated by a SIB1; and
in response to determining that the plurality of RA repetition levels is indicated by SIB1, determining an RSRP threshold for PUCCH repetition for Msg4 HARQ-ACK based on a common RSRP threshold for the plurality of RA repetition levels.

11. The method of claim 1, wherein the signaling message comprises a contention free random access (CFRA) preamble including the RA repetition levels.

12. The method of claim 11, wherein the CFRA preamble is included in a shared RACH occasion (RO) with a legacy UE.

13. The method of claim 11, wherein the CFRA preamble is included in a dedicated RO that is configured for contention based random access (CBRA).

14. The method of claim 11, wherein a RA repetition level for CFRA is configured using radio resource control (RRC) to include at least one of the PRACH repetition number, the Msg3 PUSCH repetition set, or the PUCCH repetition number for Msg4 HARQ-ACK.

15. The method of claim 11, wherein at least one of the RA repetition levels is indicated using downlink control information (DCI) Format 1_0 for a physical downlink control channel (PDCCH) order.

16. The method of claim 1, further comprising:
determining that the UE supports PRACH repetition based at least on supporting Msg3 PUSCH repetition, wherein the Msg3 PUSCH repetition includes repetition of PUSCH transmissions scheduled by random access response (RAR) uplink (UL) grant and downlink control indicator (DCI) format 0_0 with cyclic redundancy check (CRC) scrambled by temporary cell radio network temporary identifier (TC-RNTI).

17. The method of claim 1, further comprising:
determining that the UE supports PUCCH repetition for Msg4 HARQ-ACK based at least on supporting Msg3 PUSCH repetition.

18. The method of claim 1, further comprising:
determining that the UE supports PUCCH repetition for Msg4 HARQ HARQ-ACK based at least on supporting Msg3 PUSCH repetition and PRACH repetition.

19. The method of claim 1, further comprising:
determining that the UE supports PRACH repetition, Msg3 PUSCH repetition, and PUCCH repetition for Msg4 HARQ HARQ-ACK based on the UE supporting coverage enhancements in a RACH procedure.

20. The method of claim 1, further comprising:
reporting UE capability for coverage enhancements in RACH procedure per frequency band.

21. A method performed by a base station, the method comprising:
transmitting, to a user equipment (UE), a signaling message including information about one or more random access (RA) repetition levels, the RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and
establishing a connection with the UE based at least on the information about the one or more RA repetition levels.

22-23. (canceled)

24. An apparatus comprising one or more baseband processors configured to perform operations comprising:
receiving a signaling message from a base station, the signaling message including information about one or more random access (RA) repetition levels, the one or more RA repetition levels including at least one of a physical random access channel (PRACH) repetition number, a message 3 (Msg3) physical uplink shared channel (PUSCH) repetition set, or a physical uplink control channel (PUCCH) repetition number for message 4 (Msg4) hybrid automatic repeat request acknowledgement (HARQ-ACK); and
establishing a connection with the base station based at least on the information about the one or more RA repetition levels.

25-26. (canceled)
